(19) United States
(12) Patent Application Publication
(10) Pub. No.: US 2025/0335687 A1
(43) Pub. Date: Oct. 30, 2025

(54) CELL LAYOUT GENERATION DEVICE FOR INTEGRATED CIRCUIT DESIGN, SYSTEM AND METHOD USING THE SAME

(71) Applicant: AXION Co., Ltd., Seongnam-si (KR)

(72) Inventors: Kee Sup KIM, El Dorado Hills, CA (US); Younggwang JUNG, Incheon (KR); Juho LEE, Seoul (KR); Jiwoo NAM, Seoul (KR)

(21) Appl. No.: 19/075,402

(22) Filed: Mar. 10, 2025

Related U.S. Application Data
(60) Provisional application No. 63/563,381, filed on Mar. 10, 2024.

(51) Int. Cl. G06F 30/392; G06F 30/398

(52) U.S. Cl. CPC G06F 30/392; G06F 30/398

(57) ABSTRACT

The present disclosure relates to a cell layout generation device for integrated circuit design and a method using the same, and more particularly, to a cell layout generation device for integrated circuit design and a method using the same, the cell layout generation device including a cell layout generator configured to determine a placement corresponding to at least one transistor according to a predefined criterion based on data input to generate a cell layout, and generate the cell layout by determining a routing corresponding to the placement.

### CROSS-REFERENCE TO RELATED APPLICATION(S)

This application claims priority under 35 USC 119 to U.S. Provisional Application No. 63/563,381, filed on Mar. 10, 2024, the contents of which is incorporated herein by reference in its entirety.

### FIELD OF THE DISCLOSURE

The present disclosure relates to a cell layout generation device for integrated circuit design, and a method using the same.

### BACKGROUND OF THE RELATED ART

Electronic design automation (hereinafter, ‘EDA’) refers to a category of software tools used to design electronic systems, particularly, integrated circuits (ICs). Using the EDA, a chip designer may design and analyze a semiconductor chip that may contain billions of components.

To effectively design ICs using the EDA, a cell library is essential. However, most existing cell libraries have been constructed after a cell layout is manually generated. Thus, there is a problem in that automated cell layout generation is difficult.

### SUMMARY OF THE INVENTION

### Technical Problems

Accordingly, the present disclosure has been made in view of the above-mentioned problems occurring in the related art, and it is an object of the present disclosure to provide a cell layout generation device for integrated circuit (IC) design, the cell layout generation device capable of automatically generating a cell layout for IC design and optimizing the cell layout using an optimization engine, and a method using the same.

However, objects of the present disclosure are not limited to the objects described above, and other objects may be understood based on the following description.

### Technical Solution

To accomplish the above-mentioned objects, according to one aspect of the present disclosure, there is provided a cell layout generation device for integrated circuit design, the cell layout generation device including a cell layout generator configured to determine a placement corresponding to at least one transistor according to a predefined criterion based on data input to generate a cell layout, and generate a cell layout by determining a routing corresponding to the determined placement.

To accomplish the above-mentioned objects, there is provided a cell layout generation device for integrated circuit design, the cell layout generation device including: a cell layout generator configured to determine a placement corresponding to at least one transistor according to a predefined criterion based on data input to generate a cell layout, and generate a cell layout by determining a routing corresponding to the determined placement; and an optimization engine configured to derive an optimization parameter for the generated cell layout using a parameter optimization model which is provided in advance, wherein the cell layout generator generates an optimal cell layout that satisfies a predefined optimization objective by changing the generated cell layout according to the optimization parameter derived from the optimization engine.

To accomplish the above-mentioned objects, there is provided a method of generating a cell layout by a cell layout generation device for integrated circuit design, the method including: determining a placement corresponding to at least one transistor according to a predefined criterion based on data input to generate a cell layout; and generating at least one cell layout by determining a routing corresponding to the determined placement according to a predefined criterion.

To accomplish the above-mentioned objects, there is provided a method of generating a cell layout by a cell layout generation device for integrated circuit design, the method including: an initial generation operation for determining a placement corresponding to at least one transistor according to a predefined criterion based on data input to generate a cell layout, and generating a cell layout by determining a routing corresponding to the determined placement; an optimization parameter derivation operation for deriving an optimization parameter for the generated cell layout using a parameter optimization model which is provided in advance; and an optimization operation for generating an optimal cell layout that satisfies a predefined optimization objective by changing the generated cell layout according to the derived optimization parameter.

### Advantageous Effects

According to a cell layout generation device for integrated circuit design and a method of generating a cell layout in the present disclosure, a cell layout may be automatically generated by determining a placement corresponding to at least one transistor based on data input to generate a cell layout and determining a routing corresponding to the determined placement.

In addition, according to the present disclosure, when a cell layout is generated by determining placement and routings of a plurality of transistors, the generated cell layout may be optimized according to an optimization parameter derived using a parameter optimization model provided in advance. Thus, an optimized cell layout may be automatically generated and a cell library may be built without any separate intervention by a designer.

In addition, in the present disclosure, an optimal cell layout may be generated by simultaneously taking into account a plurality of trade-off optimization objectives by deriving optimization parameters according to multi-objectives.

Further, various effects other than the effects described above may be directly or implicitly disclosed in the detailed description according to an embodiment of the present disclosure to be described later.

### BRIEF DESCRIPTION OF THE DRAWINGS

The above and other objects, features and advantages of the present disclosure will be apparent from the following detailed description of the embodiments of the disclosure in conjunction with the accompanying drawings, in which:

FIG. 1 is a block diagram illustrating main components of a cell layout generation device according to an embodiment of the present disclosure;

FIGS. 2 to 4 are diagrams for explaining an operation in the cell layout generation device according to an embodiment of the present disclosure;

FIGS. 5 to 15 are diagrams illustrating examples for explaining a process of placing transistors in a placer according to an embodiment of the present disclosure;

FIGS. 16 to 20 are diagrams illustrating examples for explaining a routing process in a router according to an embodiment of the present disclosure;

FIGS. 21 to 23 are diagrams for explaining an operation of the cell layout generator in which pin accessibility is taken into account according to an embodiment of the present disclosure;

FIG. 24 is a block diagram illustrating a main configuration of a cell layout generator including a cell layout generation device according to another embodiment of the present disclosure;

FIG. 25 is a flowchart for explaining a method of generating a cell layout by a cell layout generation device according to still another embodiment of the present disclosure;

FIG. 26 illustrates an example for explaining an operation by a cell layout generation device including the cell layout generator according to still another embodiment of the present disclosure; and

FIG. 27 is a flowchart for explaining a method of generating a cell layout in the cell layout generation device according to still another embodiment of the present disclosure.

### DETAILED DESCRIPTION OF THE PREFERRED EMBODIMENT

Features and advantages of the technical solution of the present disclosure and methods of accomplishing the same may be understood more readily with reference to the following detailed description of particular embodiments of the present disclosure and the accompanying drawings.

However, certain detailed explanations of well-known functions relevant to the present disclosure are omitted when it is deemed that they may unnecessarily obscure the essence of the present disclosure. It should be noted that like reference numerals in the drawings denote like elements.

Hereinafter, terms or words used in the description and drawings should not be interpreted as being limited to have a general meaning or a meaning defined in a dictionary, but should be interpreted as having a meaning and a concept which are consistent with the technical ideas of the present disclosure, based on a principle such that an inventor may properly define concepts of the terms to explain the disclosure of the inventor by using an optimum method. Accordingly, it should be understood that embodiments in the specifications and configurations illustrated in drawings are only example embodiments, and there is no intent to limit the example embodiments to the particular forms disclosed, but on the contrary, example embodiments are to cover all modifications, equivalents, and alternatives falling within the scope of the present disclosure.

Additionally, when an element is referred to as being “connected” or “coupled” to another element, this means that the element may be logically or physically connected or coupled to the another element. In other words, it should be understood that the element may be directly connected or coupled to the another element, but intervening elements may be present or the element may be indirectly connected or coupled to the another element.

In addition, the terms used in the present specification are merely used to describe particular embodiments, and are not intended to limit the present disclosure. A singular representation may include a plural representation unless it represents a definitely different meaning from the context.

In addition, it is to be understood that the terms such as “including” or “having,” etc. described herein are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

The term “module” used in various embodiments herein may include a unit implemented in hardware, software or firmware, and may be used interchangeably with terms such as logic, logic block, component, or circuit.

In this specification, each component according to various embodiments (e.g., a module or a program) may contain one or more entities, and some of the entities may be separated and placed in other components. According to various embodiments, one or more of the aforementioned components or operations may be omitted, or one or more other components or operations may be added. Alternatively or additionally, a plurality of components (e.g. (modules or programs) may be integrated into a single component. In this case, the component resulting from the integration may perform one or more functions of each of the plurality of components identically or similarly to those performed by a corresponding component among the plurality of components before the integration.

According to various embodiments, operations performed by a module, program or other component may be performed sequentially, in parallel, iteratively, or heuristically, or one or more of the operations may be performed in a different order, omitted, or one or more other operations may be added.

Hereinafter, a cell layout generation device for integrated circuit (IC) design and a method of generating a cell layout according to an embodiment of the present disclosure are described with reference to the accompanying drawings.

First, the cell layout generation device for IC design according to an embodiment of the present disclosure is described.

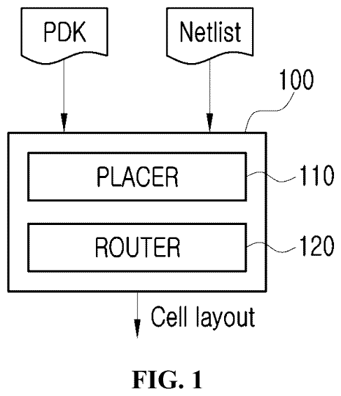

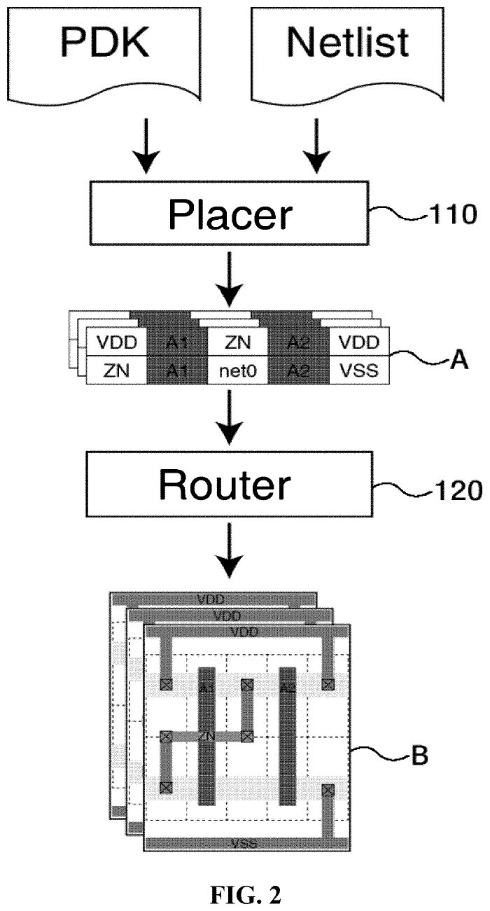

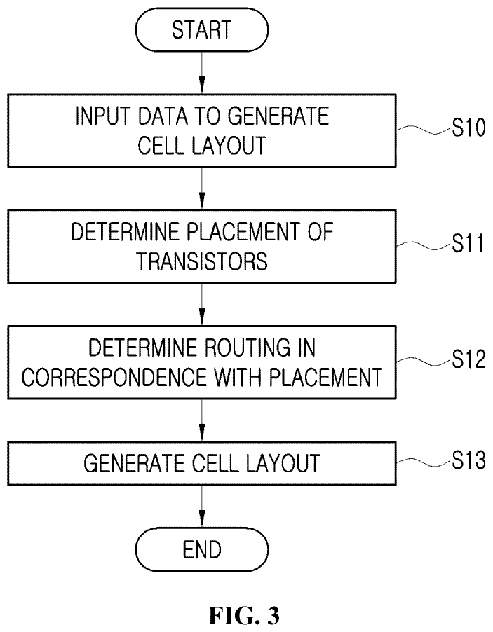

FIG. 1 is a block diagram illustrating main components of a cell layout generation device according to an embodiment of the present disclosure. FIGS. 2 to 4 are diagrams for explaining an operation in the cell layout generation device according to an embodiment of the present disclosure.

First, referring to FIG. 1, a cell layout generation device 300 according to an embodiment of the present disclosure is a device capable of generating a cell layout based on data input to generate a cell layout. At this time, the cell may be a standard cell which is a design block including a basic logic circuit, or a custom cell which is a design block optimized for a particular purpose.

Meanwhile, the input data may include circuit information including electrical connection relationships between transistors constituting a circuit for a particular logic function and process information including constraints in which an integrated circuit design manufacturing process is taken into account. The circuit information and the process information may be data input by a user, i.e., a user who intends to design an integrated circuit, or may be data automatically loaded in a prestored state.

In detail, the circuit information may be circuit connection information, and may be, for example, a netlist in which transistors corresponding to a cell layout are connected and a register transfer level (RTL) netlist constituting a chip or a block unit, but is not limited thereto. The circuit information includes electrical connection relationships between transistors constituting a circuit, and may include electrical connection relationships regarding transistors constituting a circuit that performs a particular logic function (an AND gate, an OR gate, a flip-flop, etc.), e.g., transistor or pin connections, etc.

In detail, the process information may be process design information, e.g., a process design kit (PDK), but is not limited thereto. The process information may include constraints in which an integrated circuit design manufacturing process is taken into account, e.g., constraints on process rules for enabling to generate cells to correspond to a particular semiconductor process (e.g., 5 nm, 7 nm, 28 nm, etc.). At this time, the constraints may include physical constraints such as design rules, metal layer limitations, electrical characteristics of routings, or power integrity rules.

The cell layout generation device 300 according to the present embodiment determines a placement corresponding to at least one transistor according to a predefined criterion based on data input to generate a cell layout, and determines a routing corresponding to the determined placement to generate at least one cell layout.

To do so, the cell layout generation device 300 according to the present embodiment may be configured to include a placer 110 and a router 120 to automatically generate a cell layout.

First, the placer 110 generates all of one or more placement candidates applicable in correspondence with at least one transistor capable of performing a particular logic function based on the input data, and determines at least one placement among the generated all of placement candidates according to a predefined criterion.

In relation to this, referring to FIGS. 2 to 4, when data is input to generate a cell layout (S10), the placer 110 may determine one or more placements applicable in correspondence with at least one transistor based on the input data (S11).

Transistors (a p-channel metal-oxide semiconductor (PMOS) transistor or an n-channel metal-oxide semiconductor (NMOS) transistor) configured to perform a logic function (AND, OR, NOT, etc.) may be placed in one cell. The placer 110 in the present embodiment may generate placement candidates for transistors applicable to configure a cell that implements the logic function. At this time, placement candidates A may be generated in an arrangement form according to a placement order of the transistors as shown in FIG. 2. Then, the placer 110 in the present embodiment may determine at least one placement among all the placement candidates according to a predefined criterion. For example, the placer 110 may determine an optimal placement based on a predefined cost function value.

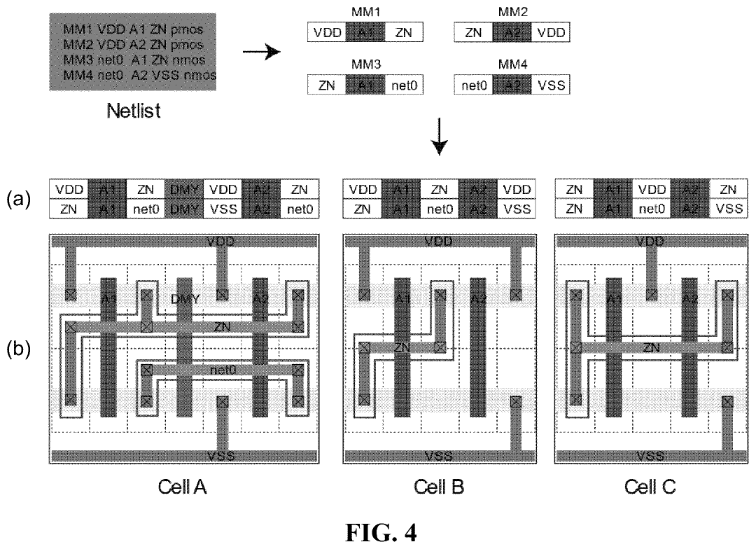

With respect to the process described above, referring to FIG. 4 as an example, the placer 110 in the present disclosure may identify four transistors MM1, MM2, MM3, and MM4 configured to perform particular logic functions based on data (netlist and PDK) input to generate a cell layout, and check an electrical connection relationship between the four transistors. In addition, as shown in (a) of FIG. 4, the placer 110 may generate possible placement candidates for the transistors. At this time, the placer 110 may evaluate all of the placement candidates using a predefined cost function including at least one element of a cell width, a wirelength, and a pin access, and determine a placement with a lowest calculated cost as a final placement.

Then, the router 120 in the present embodiment generates one or more routing candidates applicable in correspondence with the placement determined by the placer 110, and determines at least one routing among all of the generated routing candidates according to a predefined criterion to generate the cell layout.

In detail, the router 120 in the present embodiment may determine one or more routings applicable in correspondence with each placement determined by the placer 110 (S12). To do so, the router 120 in the present embodiment generates all possible routing candidates B in correspondence with each placement as illustrated in FIG. 2, and then, determines one of the generated routing candidates B according to a predefined criterion to automatically generate a cell layout. Meanwhile, the router 120 in the present embodiment may determine one routing candidate according to a design objective derived from input data, e.g., quantitative values such as performance, power, an area, and a wirelength.

FIG. 4 shows that each of cell layouts Cell A, Cell B, and Cell C is generated in correspondence with each placement. Depending on an implementation method, the router 120 in the present disclosure may finally generate one desirable cell layout among the cell layouts Cell A, Cell B, and Cell C. At this time, a cost function according to a design objective may be additionally used to finally generate a cell layout.

The main components and operation of the cell layout generation device 300 according to an embodiment of the present disclosure have been briefly described above.

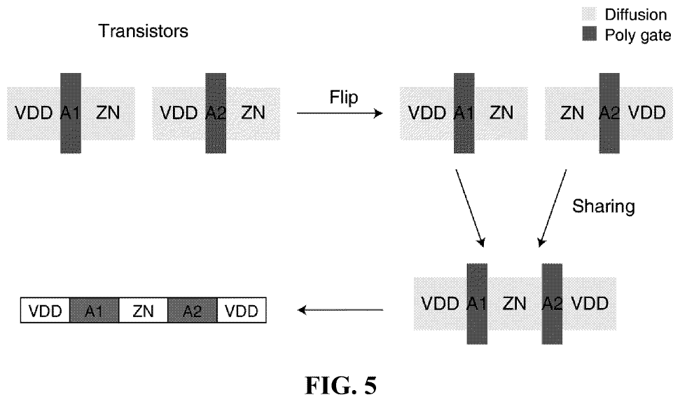

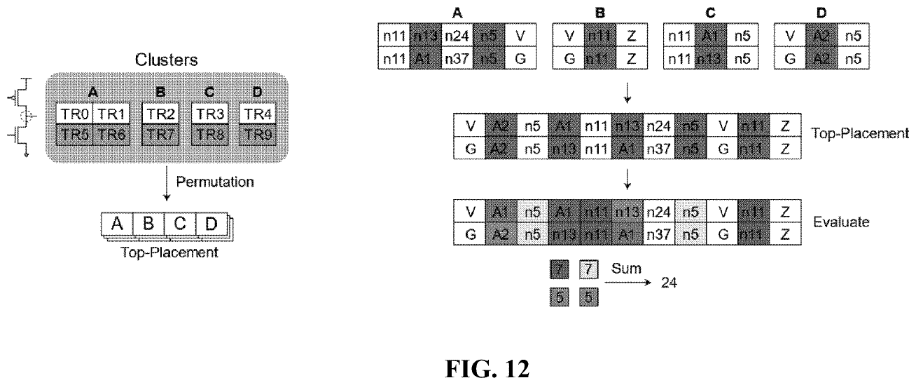

Hereinafter, by referring to FIGS. 5 to 20, processes of performing placement and routing by the placer 110 and the router 120 according to an embodiment of the present disclosure is described in detail.

First, a placement process by a placer according to an embodiment of the present disclosure is described with reference to the drawings.

FIGS. 5 to 15 are diagrams illustrating examples for explaining a process of placing transistors in a placer according to an embodiment of the present disclosure.

As described above, the placer 110 in the present embodiment may determine placement of transistors based on input data (netlist and PDK). At this time, the placer 110 may place at least one transistor to implement a particular logic function defined in the input data (netlist and PDK). For example, when the placer 110 in the present embodiment is to implement a NAND (Not AND) gate function, placement of PMOS transistors and NMOS transistors may be determined according to connection information checked through the netlist.

In particular, the placer 110 in the present embodiment may generate all placement candidates applicable in correspondence with transistors in the process of placing transistors described above, and determine one placement among all the generated placement candidates according to a predefined criterion. For example, as illustrated in FIG. 5, the placer 110 in the present embodiment may flip directions of some transistors constituting a NAND gate, and adjust the placement so that the NMOS transistors may share a diffusion region with each other.

Here, the diffusion region is a portion arranged between a source electrode and a drain electrode of a transistor. When the diffusion region is shared between a plurality of transistors, a cell width may be reduced. Accordingly, the placer 110 in the present disclosure may determine transistor placement according to a cost function including a cell area element according to the diffusion region. That is, by flipping a ZAN transistor and combining a NAZ transistor with the ZAN transistor, transistors may be placed (NAZAN) to minimize an area cost by taking into account sharing of diffusion regions between respective transistors.

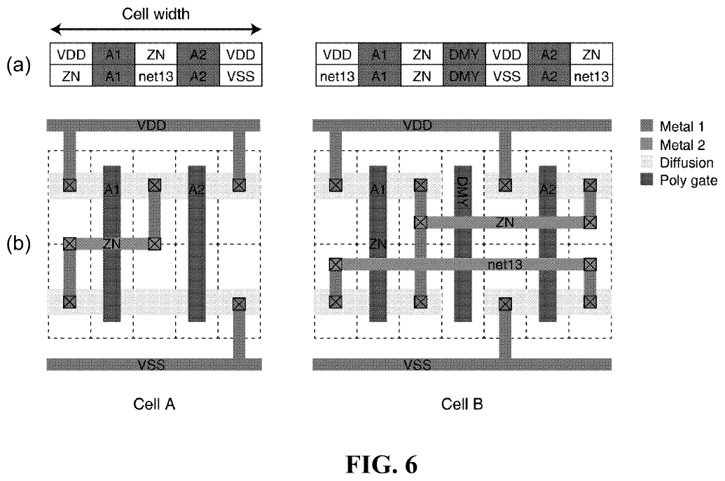

As illustrated in FIG. 6, a placement (a) determined in the placer 110 in the present embodiment may lead to a routing (b) in which a wirelength resource in the router 120 may be reduced.

Meanwhile, the placer 110 in the present embodiment may perform placement according to steps through a logical unit clustering process to efficiently place transistors.

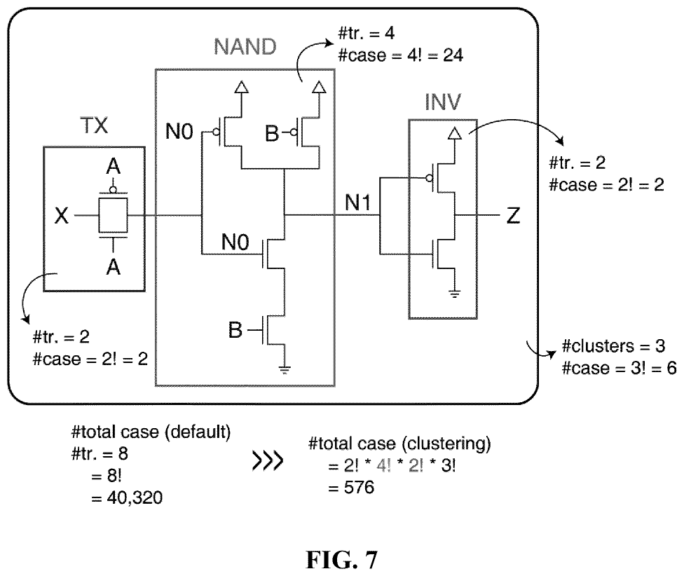

First, as illustrated in FIG. 7, the placer 110 in the present embodiment may analyze logical connectivity between transistors to group transistors that are strongly connected to each other into one cluster. That is, although numerous transistors are needed to implement one logical function, a number of cases of placement of all transistors may be increased significantly according to an increase in a number of the transistors. Thus, the placer 110 in the present embodiment may first perform a clustering process to effectively determine placement of transistors, then, place the transistors in clusters, and then, determine placement between the clusters, thereby enabling more effective placement of the transistors.

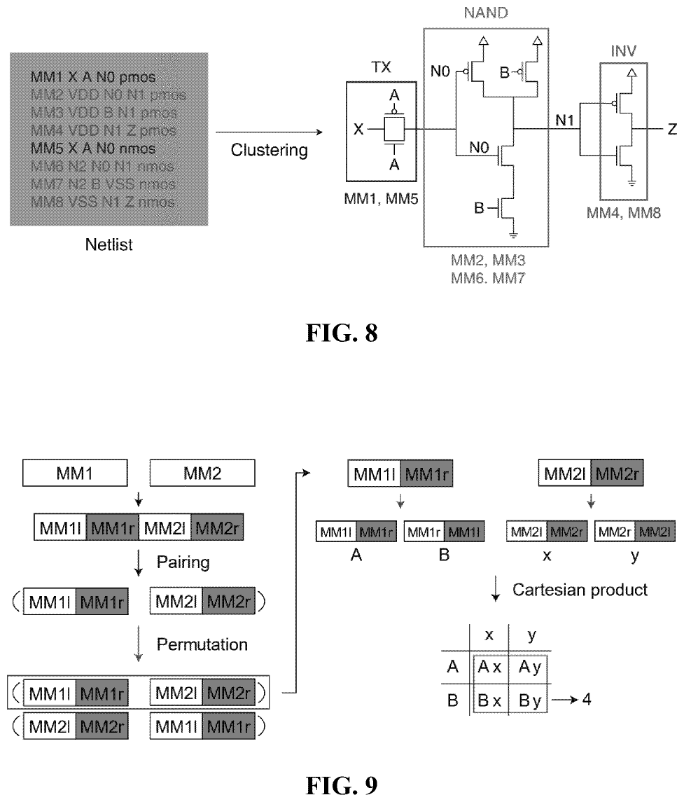

To do so, as illustrated in FIG. 8, the placer 110 in the present embodiment checks information (a source-drain connection relationship, VDD, VSS, etc.) regarding a plurality of transistors MMI1, MMI2, MMI3, MMI4, MMI5, MMI6, MMI7, and MMI8 for a particular logic function based on the netlist, and then, checks transistor source-drain connection information using the checked information and clusters transistors connected to a same signal network (net) to generate at least one cluster.

Then, as illustrated in FIG. 9, the placer 110 in the present embodiment may perform sub-placement for determining placement of respective transistors in one cluster.

As a process of performing the sub-placement, the placer 110 according to the present embodiment may check the transistors MM1 and MM2 clustered within one cluster, and through this, define an ordered pair (MM1lMM1r, MM2lMM2r) in which the respective transistors are separated into a source and a drain, i.e., 1 and r. Then, the placer 110 in the present embodiment generates possible placement candidates based on the defined ordered pair (MM1lMM1r, MM2lMM2r). For example, placement candidates ((MM1lMM1r, MM2lMM2r), (MM2lMM2r, MM1lMM1r)) may be generated through a permutation process for arrangement in a form in a particular order, e.g., by changing an internal order of transistors, changing between transistors, etc. Meanwhile, the permutation process may be performed on all ordered pairs. For example, all possible placement candidates may be generated, for example, through a Cartesian product operation.

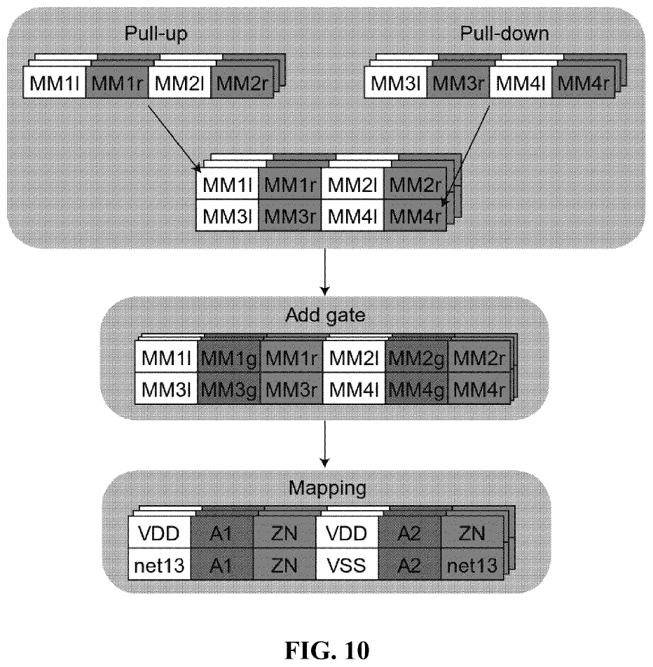

A process of the sub-placement by the placer 110 is described further with reference to FIG. 10.

Transistors in a cluster are divided into transistors corresponding to a PMOS region and transistors corresponding to an NMOS region. Accordingly, the placer 110 in the present embodiment may merge transistor placement candidates classified into the PMOS region (pull-up) and the NMOS region (pull-down), add gates to the transistor placement candidates in a state of the merging, and map transistors defined in a netlist to the placement candidates to which the gates have been added.

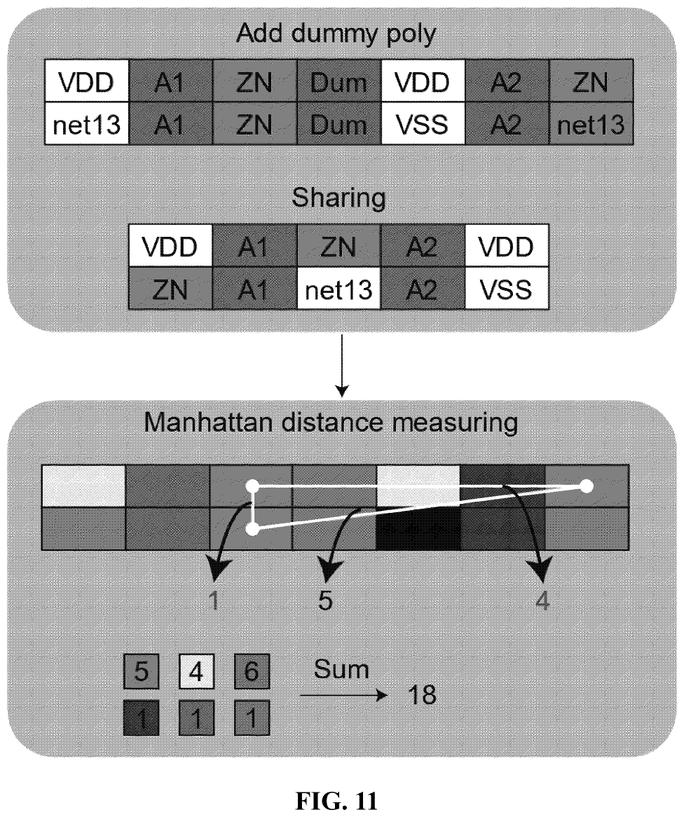

The process of sub-placement by the placer 110 is described further with reference to FIG. 11.

As illustrated in FIG. 11, the placer 110 in the present embodiment determines whether diffusion region sharing may be performed. When the diffusion region sharing may be performed, a diffusion region is shared, and when the diffusion region sharing may be not performed, a dummy poly may be inserted (added) between poly gates to separate regions. Here, the dummy poly is used to maintain uniform process characteristics. By inserting the dummy poly, even in a situation in which diffusion regions may not be shared, transistors that satisfy design rules may be placed while preventing electrical interference.

Then, the placer 110 in the present embodiment may measure a distance between respective transistors for respective placement candidates generated through the above-described process, and select a placement candidate with a minimum cell area based on the measured distance to thereby complete a setting for final transistor placement with respect to a corresponding cluster. At this time, the placer 110 in the present embodiment may measure a distance between respective transistors according to a preset distance measurement technique, such as a Manhattan distance. Meanwhile, in the present embodiment, placement of transistors is determined based on a distance between the transistors, but this is only an example. It is obvious that placement of transistors may be determined by applying other measurement methods to the transistors.

The sub-placement process may be performed on each of all clusters. When the sub-placement described above is completed for each of all the clusters, the placer 110 in the present embodiment may perform top-placement, which is placement between clusters.

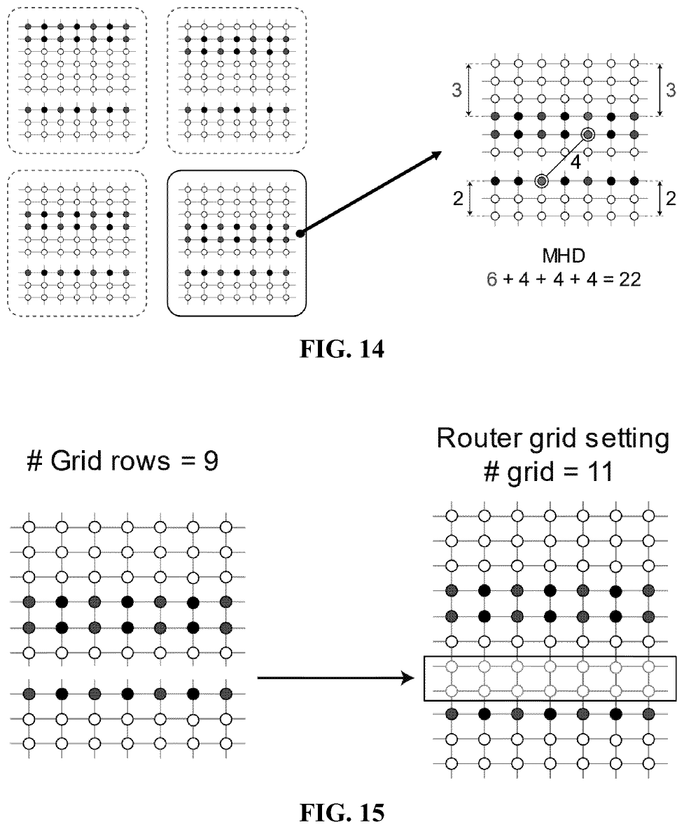

In relation to this, referring to FIG. 14, when it is assumed that clusters A, B, C, and D are present, permutation may be performed on the clusters to generate placement candidates for the clusters A, B, C, and D. At this time, like the sub-placement, the placer 110 in the present embodiment may determine whether diffusion region sharing may be performed, and when diffusion region sharing may not be performed, a dummy poly may be inserted, thereby optimizing connection of transistors during placement between clusters. Then, when placement is performed through a combination between the clusters, the placer 110 in the present embodiment may set, as a final cluster placement, a combination in which a wirelength (a distance) between respective clusters is minimized. Thus, the placement of a plurality of clusters may be completed.

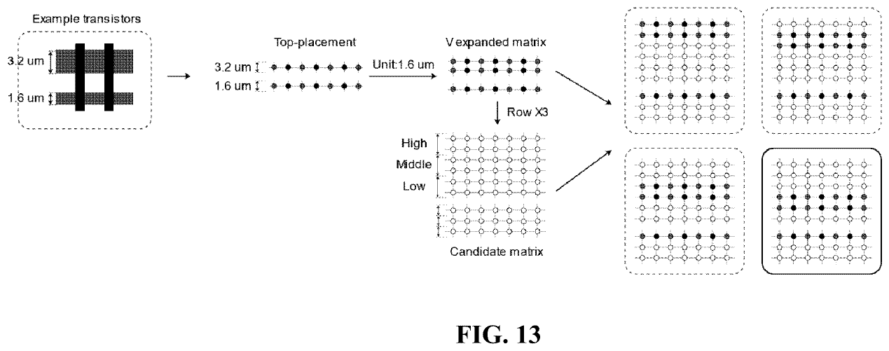

Meanwhile, as described above, the placement is determined according to a process of the top-placement. However, in this case, the placement of transistors indicates an order of the transistors, and needs to be performed by taking into account actual widths of the transistors. To do so, the placer 110 in the present embodiment performs vertical-placement (V-placement) as illustrated in FIG. 13.

Referring to FIG. 13, when it is assumed that transistors 1 and 2 are present, the placer 110 in the present embodiment may check a transistor size and design constraints checked through a PDK. At this time, when a height of the transistor 1 is 3.2 μm and a height of transistor 2 is 1.6 μm, vertical placement of the transistors need to be performed, i.e., based on a height. Therefore, a cell layout that satisfies a height of 3.2 μm adjustable in a unit of 1.6 μm needs to be generated. To do so, the placer 110 in the present embodiment may generate a grid by expanding a row to a predetermined range according to a transistor width. Based on the grid generated as a result of the expanding, the placer 110 in the present embodiment may match various placement candidates. Then, as illustrated in FIG. 14, the placer 110 in the present embodiment may determine one placement candidate with a minimum distance (a wirelength) among the respective placement candidates that match the grid, and place transistors for the determined placement candidate to complete a final placement process.

As described above, the placer 110 performs clustering-based placement according to steps when placing transistors, and automatically determines a placement based on a preset criterion for each step, thereby enabling efficient transistor placement.

In addition, as the placer 110 in the present disclosure performs the V-placement to place transistors on a grid, the router 120 in the present disclosure may insert an additional grid as needed when a routing is determined, as shown in FIG. 15. At this time, the grid may be inserted based on a unit length for routing optimization.

Hereinafter, a process of determining a routing by the router 120 in the present disclosure is described in detail.

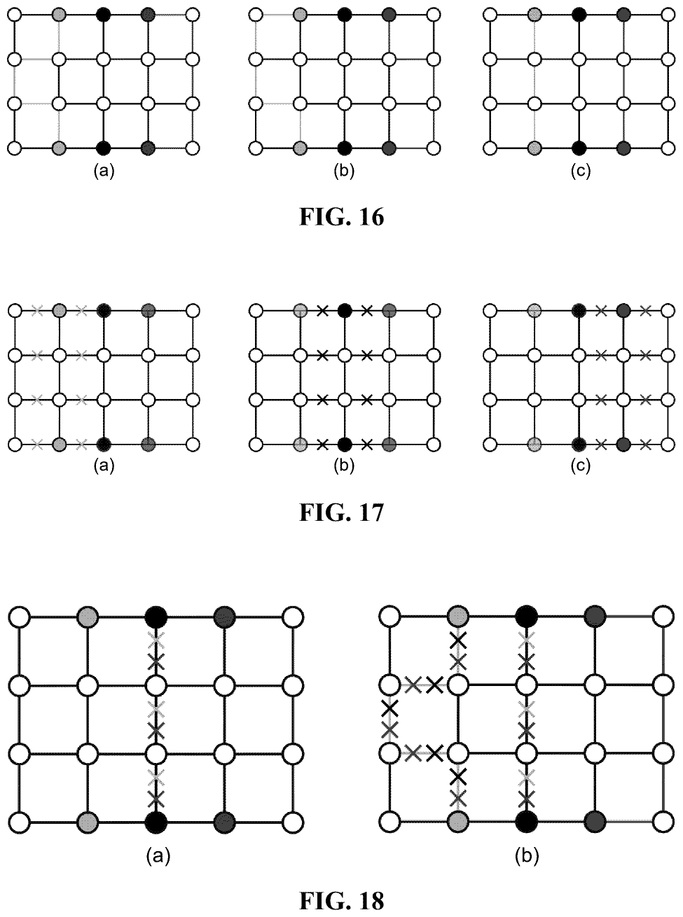

FIGS. 16 to 20 are diagrams illustrating examples for explaining a routing process in a router according to an embodiment of the present disclosure.

First, referring to FIG. 16, the router 120 in the present embodiment may perform an efficient routing determination process in correspondence with each placement determined by the placer 110. To do so, the router 120 in the present embodiment may be set as a router that satisfies a grid and a satisfiability modulo theory (SMT), and in detail, derive a solution that satisfies all design objectives derived from a PDK on the grid according to the SMT, and automatically determine a routing (c) according to the derived solution.

At this time, the router 120 in the present embodiment may take into account characteristics of respective individual routings (net) to set design objectives for the respective routings, rather than setting a same design objective for each routing. For example, since clock signal routings, data signal routings, and power supply and ground wires have different characteristics, different design objectives may be set by considering characteristics of the respective routings. That is, as illustrated in FIG. 17, the router 120 in the present embodiment may set different design objectives (constraints according to routing characteristics) according to routing characteristics, such as blue constraints (a), red constraints (b), and green constraints (c). In addition, as illustrated in FIG. 18, the router 120 in the present embodiment may take into account correlations between respective routings to further set a constraint such that when one routing uses a particular path (an edge), other routings do not use the particular path. By doing so, routing conflicts and interference between signals may be prevented.

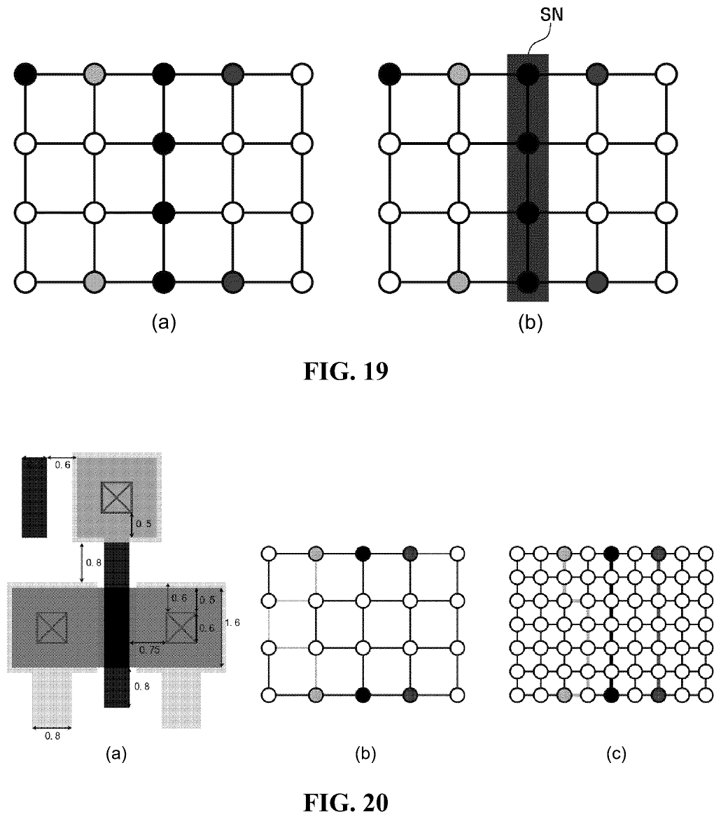

In addition, as illustrated in FIG. 19, like a gate poly node, since a PMOS region and an NMOS region may be connected as one continuous node when located in a same column, the router 120 in the present embodiment may set a routing for one super node (SN) without separately placing an individual poly node, and then, set a routing for transistors. By doing so, a cell layout in which a routing path is minimized may be generated.

In addition, as illustrated in FIG. 20, a phenomenon in which an additionally inserted grid (b) does not match a design rule (a) in the design objective checked through the PDK may occur in the router 120. For example, as illustrated in (b), when it is checked that a basic grid unit of a determined routing is 0.1 μm but a routing space of transistors checked through the design objective is 0.07 μm, the grid unit does not match the routing space. Thus, the router 120 in the present embodiment may change the grid unit to be smaller in a multiple of units (Nx), that is, to a finer grid in a form illustrated in (c). By doing so, a precise routing may be set.

Meanwhile, the router 120 in the present embodiment may further perform routing optimization in which layers are taken into account, by considering a case of being applied to a FinFET process. For example, the router 120 in the present embodiment may expand a number of vertical tracks by considering a gear ratio, i.e., a ratio between a poly pitch and a metal-1 pitch (M1 pitch), and optimize a routing in a form in which a contact or a via is placed only in a portion where tracks of respective layers overlap each other.

Meanwhile, the cell layout generation device 300 according to another embodiment of the present disclosure may additionally expand a plurality of cell layouts by further taking into account pin accessibility, with respect to a cell layout generated through the above-described process.

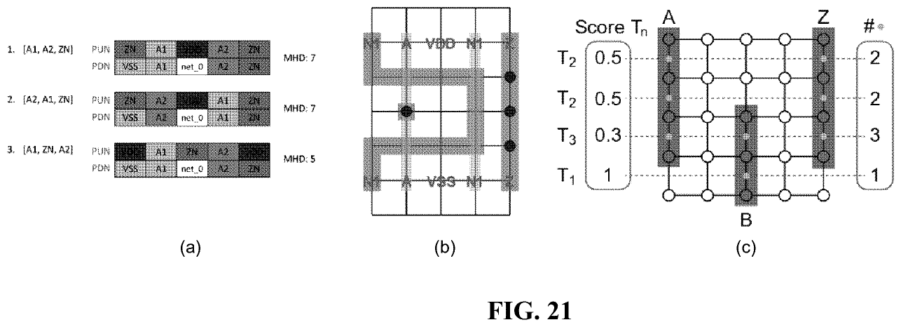

FIGS. 21 to 23 are diagrams for explaining an operation of the cell layout generator in which pin accessibility is taken into account according to an embodiment of the present disclosure. A cell layout generator 100 according to the present embodiment may increase flexibility of routing optimization by generating a plurality of cell layouts having several different pin locations in correspondence with an input netlist. At this time, the routing optimization may mean improvement of pin accessibility within a cell, or have a concept of increasing overall routing flexibility during chip implementation, or refer to improvement of RC parameters.

First, as illustrated in (a) of FIG. 21, the placer 110 in the present embodiment may generate a plurality of placements 1, 2, and 3 including different pin positions in one axis (e.g., x-axis) direction.

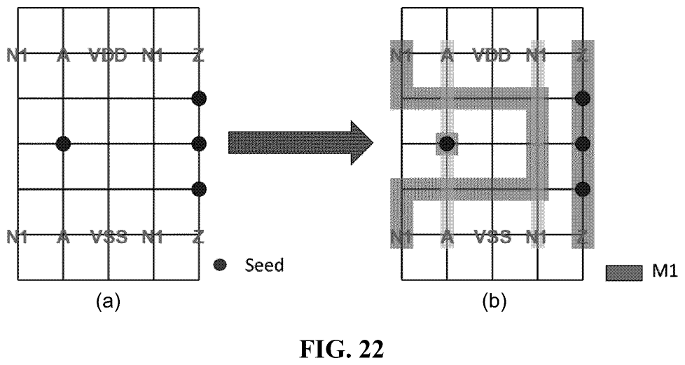

The router 120 in the present embodiment may determine a routing using a method of correcting the pin positions of the plurality of placements 1, 2, and 3 determined by the placer 110 and scoring pin accessibility. In detail, as illustrated in (b) of FIG. 21, the router 120 in the present embodiment may select a seed pin. Referring to FIG. 22, which is a detailed drawing of (b) of FIG. 21, the router 120 in the present embodiment selects a seed pin in a placement including different pin positions as shown in (a), and extends a routing path with reference to the selected seed pin as shown in (b). In addition, as shown in (c) of FIG. 21, the router 120 in the present embodiment calculates a pin score for pin accessibility based on a number of pin intersections with a track which is a routing path from the seed pin.

In detail, the router 120 in the present embodiment assign a score based on a number of pin intersections that intersect a track. The router 120 in the present embodiment may assign a low score when a number of intersections between sub-upper layer tracks and pins is great. For example, when M1 (a metal layer 1) and M2 (a metal layer 2) are present, the router 120 in the present embodiment calculates a pin score by considering an intersection between a pin M1 and a track M2. For example, when the track M2 intersects two pins M1, 0.5 point is given, and when the track M2 intersects one pin M1, one point is given. As such, scores may be assigned such that a score Tn of a corresponding track is decreased when a number of intersecting pins M1 increases.

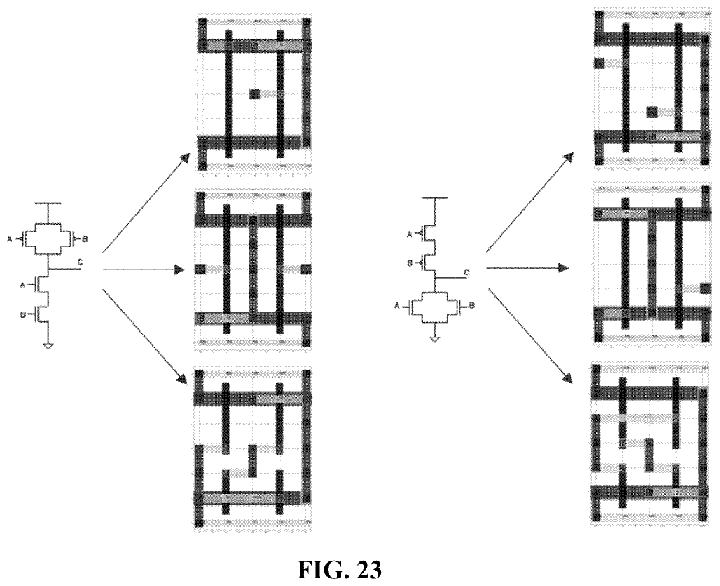

Then, the router 120 in the present embodiment may determine scores of respective pins by adding up scores of tracks that intersect corresponding pins. For example, when a pin A intersects two tracks having a score of T2 and one track with a score of T3, a score of the pin A may be T2+T2+T3. The router 120 in the present embodiment may optimize a routing path to maximize a total score by adding up scores of all pins calculated through the above-described process, and finally generate a plurality of additional cell layouts as illustrated in FIG. 23. By doing so, a cell layout library that varies depending on pin accessibility may be generated.

The cell layout generation device 300 according to still another embodiment of the present disclosure may perform a process of generating an optimized cell layout by continuously optimizing a cell layout generated by interoperating with an optimization engine.

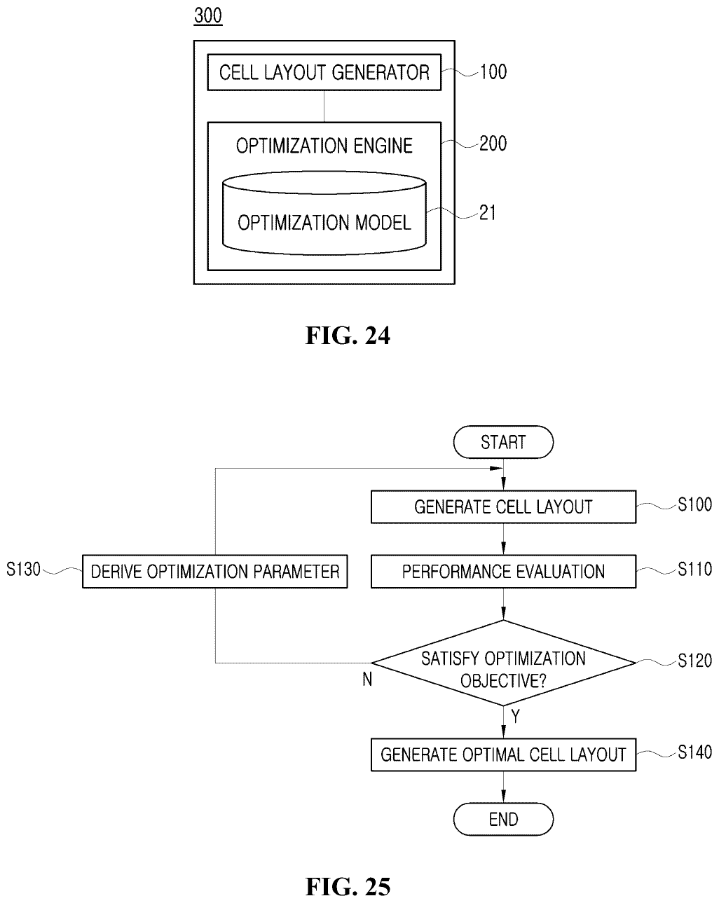

A configuration in which the cell layout generation device 300 in the present embodiment performs an operation by interoperating with an optimization engine is described with reference to FIGS. 24 to 27.

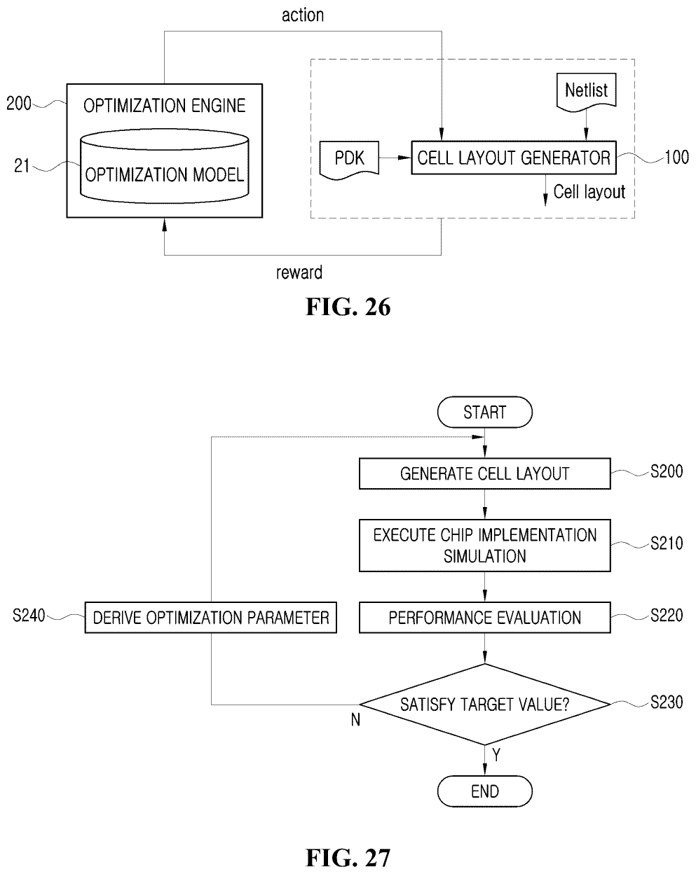

FIG. 24 is a block diagram illustrating a main configuration of a cell layout generator including a cell layout generation device according to another still embodiment of the present disclosure. FIG. 25 is a flowchart for explaining a first operation by the cell layout generation device including the cell layout generator according to still another embodiment of the present disclosure. FIG. 26 illustrates an example for explaining the first operation by the cell layout generation device including the cell layout generator according to still another embodiment of the present disclosure. FIG. 27 is a flowchart for explaining a second operation by the cell layout generation device including the cell layout generator according to still another embodiment of the present disclosure.

First, referring to FIG. 24, the cell layout generation device 300 according to still another embodiment of the present disclosure may be configured to include the cell layout generator 100 and an optimization engine 200 including a parameter optimization model 21 which is provided in advance.

First, the cell layout generator 100 in the present embodiment may play a function of determining a placement corresponding to at least one transistor according to a predefined criterion based on data input to generate a cell layout, and determining a routing corresponding to the determined placement to generate a cell layout. At this time, the cell layout generator 100 in the present embodiment may perform a same function as that of the cell layout generation device 300 illustrated in FIG. 1.

The optimization engine 200 in the present embodiment performs a function of deriving an optimization parameter for a cell layout generated by the cell layout generator 100 using the parameter optimization model 21 and transmitting the derived optimization parameter to the cell layout generator 100.

The cell layout generator 100 and the optimization engine 200 in the present embodiment may desirably repeat an optimization process until the generated cell layout satisfies a predefined optimization objective.

In relation to this, referring to FIG. 25, the cell layout generator 100 in the present embodiment generates a cell layout based on input data (netlist and PDK) (S100). At this time, the cell layout generated based on the input data without an optimization parameter refers to an initial cell layout.

Thereafter, the optimization engine 200 in the present embodiment performs a performance evaluation on the initial cell layout (S110) and determines whether the predefined optimization objective is satisfied (S120). When the predefined optimization objective is not satisfied, the optimization engine 200 in the present embodiment applies the initial cell layout to the optimization model 21 to derive an optimization parameter (S130). The derived optimization parameter is transmitted back to the cell layout generator 100. Thus, the cell layout generator 100 reflects the optimization parameter to generate an optimal cell layout (S140).

At this time, in an embodiment, as illustrated in FIG. 26, the optimization parameter may be derived by adjusting a particular parameter value, i.e., an action to maximize a reward based on reinforcement learning. For example, when minimization of a wirelength is a predefined optimization objective, the optimization parameter refers to a parameter derived according to an action of adjusting a parameter value related to the minimization of the wirelength to achieve the optimization objective.

The optimization parameter derived from performance of the action is transmitted to the cell layout generator 100. Then, the cell layout generator 100 may perform an optimization process using a feedback method of performing an action of changing a cell layout, evaluating whether a cell layout obtained as a result of the changing has a minimized wirelength compared to a wirelength of the cell layout before the changing by using a reward function, and adjusting a parameter value again according to the reward function.

An example of deriving an optimization parameter through a parameter optimization model based on reinforcement learning according to an embodiment of the present disclosure has been described above. However, the present disclosure is not limited thereto, and any optimization technique capable of optimizing a parameter according to feedback other than the reinforcement learning may be applied to the optimization model 210 in the present disclosure. For example, a method such as optimization using learning like neural networks, Bayesian optimization, etc., or gradient-based optimization which performs optimization using a differentiable objective function may be used.

In addition, the predefined optimization objective in the present disclosure may be an objective predefined by taking into account design objectives such as area optimization, wirelength optimization, power optimization, pin accessibility, and power-ground rail optimization. Among such design objectives, the area optimization may be an objective to minimize a number of tracks while a width of a cell is fixed, i.e., optimize a space between transistors to minimize a cell height, or an objective to optimize a width while a height of the cell is fixed. The wirelength optimization may be an objective to improve pin accessibility by matching signal delay and transition time to a desired target value. The power optimization may be an objective to reduce power loss and maximize power efficiency by minimizing resistance-capacitance (RC) delay. The pin accessibility optimization may be an objective to set routing connections and reduce design complexity by adjusting pin locations for optimization.

The optimization engine 200 in the present disclosure may perform a performance evaluation on the generated cell layout to calculate at least one performance index among routings, power, pin accessibility, etc., and then, repeatedly derive the optimization parameter until a target value is reached, the target value being preset for a degree to which the calculated performance index reaches a predefined optimization objective.

In addition, depending on an implementation method, the predefined optimization objective in the present disclosure may be multiple optimization objectives (multi-objectives) including at least two objectives simultaneously. For example, the optimization objective of the present disclosure may be multi-objectives in which trade-off objectives need to be taken into account simultaneously, such as objectives of wirelength optimization (minimization) and pin accessibility optimization (maximization).

The multi-objectives may be defined using an objective function as presented in Equation below.

$$α WL + β {A}_{pin} \qquad < Equation 1 >$$

At this time, α is an importance weight for the objective of the wirelength optimization (WL), and β is an importance weight for the pin accessibility optimization (Pain) objective, and may be preset by simultaneously considering two or more trade-off objectives.

To do so, the optimization engine 200 according to the present embodiment may find optimization point that satisfies the multi-objectives, and calculate the optimization parameter by reflecting the importance weights for respective optimization objectives according to the optimization point.

That is, an importance weight in a multi-objective function is explored from an optimization point which is not inferior to all objectives. The optimization point may be explored using Pareto frontier which is a boundary curve of a set of non-dominated solutions.

By doing so, the optimization engine 200 in the present embodiment derives an optimization parameter adjustable to approach the multi-objectives, and the cell layout generator 100 performs an optimization process of changing a cell layout according to the optimization parameter.

The above-described optimization process is terminated when the optimization objective is reached, thereby generating optimal cell layouts. Finally, the cell layout generation device 300 in the present disclosure may generate a cell library which is a set of the optimal cell layouts.

Hereinafter, a method of generating a cell layout according to still another embodiment of the present disclosure is described with reference to FIG. 25.

The method of generating a cell layout by a cell layout generation device for IC design according to the present embodiment may include configurations such as generating a cell layout by a cell layout generator (S100), performing a performance evaluation by an optimization engine (S110), deriving an adjustable optimization parameter depending on whether an optimization objective is satisfied (S120 and S130), and changing, by the cell layout generator 100, the cell layout depending on the optimization parameter (S140). Respective operations performed by the cell layout generator and the optimization engine described above are identical to those in the process in the respective configuration described above. Thus, a description thereof is not provided here.

Meanwhile, depending on an implementation method, the optimization process in the present disclosure may be performed after chip implementation simulation is executed. Hereinafter, a method of generating a cell layout according to still another embodiment of the present disclosure is described with reference to FIG. 27.

The method of generating a cell layout by a cell layout generation device for IC design according to the present embodiment is performed by repeating a process of generating a cell layout by a cell layout generator (S200), performing a performance evaluation by an optimization engine (S220), executing simulation on chip implementation (S210), performing a performance evaluation of a cell layout in which the simulation on the chip implementation is executed (S220), determining whether a preset target value is satisfied (S230), and deriving an optimization parameter until the target value is satisfied (S240), and a process of generating a cell layout according to the derived optimization parameter (S200).

This process may include design-aware cell layout optimization. By optimizing a cell layout to match characteristics of a particular design, optimization may be performed according to requirements of the particular design, rather than considering only individual cell characteristics.

In addition, depending on an implementation method, the optimization engine 200 in the present disclosure may derive an optimization parameter for continuously optimizing a cell layout in a process of generating the cell layout, and may also derive an optimization parameter for cell layout optimization even after chip implementation simulation is executed.

A cell layout generation device for integrated circuit (IC) design according to an embodiment of the present disclosure and a method of generating a cell layout have been described above.

A method of generating a cell layout in the present disclosure may be provided in a form of a computer-readable medium suitable for storing computer program instructions and data thereon.

Computer-readable media suitable for storing computer program instructions and data include, for example, magnetic media such as a hard disk, a floppy disk, and a magnetic tape, optical media such as a compact disk read only memory (CD-ROM) and a digital video disk (DVD), magneto-optical media such as a floptical disk, and semiconductor memories such as a read only memory (ROM), a random access memory (RAM), a flash memory, an erasable programmable ROM (EPROM), and an electrically erasable programmable ROM (EEPROM). A processor and a memory may be supplemented by or integrated into logic circuitry for a special purpose.

In addition, the computer-readable recording medium may also be distributed over network coupled computer systems so that the computer-readable code is stored and executed in a distributed fashion In addition, functional programs for implementing the present disclosure and codes and code segments related thereto may be easily construed or changed by programmers in the technical field to which the present disclosure belongs, by taking into consideration a system environment of a computer configured to execute a program by reading recording media.

In addition, a computer program recorded on a computer-readable recording medium as described above includes instructions that perform the functions described above, and is distributed and circulated through the recording medium, and is read by, and installed and executed on a particular device or a particular computer, thereby executing the functions described above.

Although the present disclosure has been described with reference to an embodiment illustrated in the drawings, this is only an example, and it will be understood by those of ordinary skill in the art that various changes in the form and details may be made therein without departing from the spirit and scope of the present disclosure as defined by the following claims.

### EXPLANATION OF REFERENCE NUMERALS

100: Cell layout generator
200: Optimization engine
300: Cell layout generation device

1. A cell layout generation device for integrated circuit design, the cell layout generation device comprising a cell layout generator configured to determine a placement corresponding to at least one transistor according to a predefined criterion based on data input to generate at least one cell layout, and generate the at least one cell layout by determining a routing corresponding to the placement.

2. The cell layout generation device of claim 1, wherein the data input to generate the at least one cell layout comprises:
circuit information including an electrical connection relationship between transistors constituting a circuit for a particular logic function; and
process information including constraints in which an integrated circuit design manufacturing process is taken into account.

3. The cell layout generation device of claim 1, wherein the cell layout generator comprises:
a placer configured to generate one or more placement candidates applicable in correspondence with the at least one transistor capable of performing a particular logic function based on the data input, and determine at least one placement among the one or more placement candidates according to the predefined criterion; and
a router configured to generate one or more routing candidates applicable in correspondence with the at least one placement, and generate the at least one cell layout by determining at least one routing among the one or more routing candidates according to a predefined criterion.

4. The cell layout generation device of claim 3, wherein the cell layout generator additionally expands a plurality of cell layouts by taking into account pin accessibility to the at least one cell layout.

5. The cell layout generation device of claim 4,
wherein the placer generates a plurality of placements comprising different pin positions in one axis direction, and
wherein the router generates the plurality of cell layouts by determining the routing through a method of correcting pin positions in the plurality of placements comprising the different pin positions and scoring pin accessibility.

6. A cell layout generation device for integrated circuit design, the cell layout generation device comprising:
a cell layout generator configured to determine a placement corresponding to at least one transistor according to a predefined criterion based on data input to generate a cell layout, and generate the cell layout by determining a routing corresponding to the placement; and
an optimization engine configured to derive an optimization parameter for the cell layout using a parameter optimization model provided in advance,
wherein the cell layout generator generates an optimal cell layout satisfying a predefined optimization objective by changing the cell layout according to the optimization parameter derived from the optimization engine.

7. The cell layout generation device of claim 6, wherein the cell layout generation device repeatedly performs a process including:
when the cell layout generated by the cell layout generator is transmitted to the optimization engine, the optimization engine evaluates whether the cell layout satisfies the predefined optimization objective, derives a new optimization parameter when the predefined optimization objective is not satisfied, and transmits the new optimization parameter to the cell layout generator, and the cell layout generator changes the cell layout according to the new optimization parameter, and
the process is repeatedly performed until the optimal cell layout satisfying the predefined optimization objective is generated.

8. The cell layout generation device of claim 7, wherein the optimization engine calculates at least one performance index by performing a performance evaluation on the cell layout, and repeatedly derives the optimization parameter until the at least one performance index reaches a preset target value.

9. The cell layout generation device of claim 7, wherein the optimization engine performs a chip implementation simulation performance evaluation on the cell layout to repeatedly derive the optimization parameter until the chip implementation simulation performance evaluation reaches a preset target value.

10. The cell layout generation device of claim 7, wherein, when the predefined optimization objective comprises multiple optimization objectives (multi-objectives) comprising at least two optimization objectives, the optimization engine finds an optimization point satisfying the multiple optimization objectives and calculates the optimization parameter by reflecting an importance weight for each of the multiple optimization objectives according to the optimization point.

11. A method of generating a cell layout by a cell layout generation device for integrated circuit design, the method comprising:
determining a placement corresponding to at least one transistor according to a predefined criterion based on data input to generate a cell layout; and
generating at least one cell layout by determining a routing corresponding to the placement according to a predefined criterion.

12. The method of claim 11, wherein the determining the placement comprises generating one or more placement candidates applicable in correspondence with the at least one transistor capable of performing a particular logic function based on the data input, and determining at least one placement among the one or more placement candidates according to the predefined criterion; and
wherein the generating the at least one cell layout comprises generating one or more routing candidates applicable in correspondence with the at least one placement, and generating the at least one cell layout by determining at least one routing among the one or more routing candidates according to the predefined criterion.

13. A method of generating a cell layout by a cell layout generation device for integrated circuit design, the method comprising:
a cell layout generation operation determining a placement corresponding to at least one transistor according to a predefined criterion based on data input to generate a cell layout, and generating the cell layout by determining a routing corresponding to the placement;
an optimization parameter derivation operation deriving an optimization parameter for the cell layout using a parameter optimization model provided in advance; and
an optimization operation generating an optimal cell layout satisfying a predefined optimization objective by changing the cell layout according to the optimization parameter.

14. The method of claim 13, wherein the optimization operation comprises, until the optimal cell layout satisfying the predefined optimization objective is generated, repeatedly performing:
evaluating whether the cell layout satisfies the predefined optimization objective;
deriving a new optimization parameter when the predefined optimization objective is not satisfied; and
changing the cell layout according to the new optimization parameter.
